(19) United States
(12) Patent Application Publication
(10) Pub. No.: US 2009/0223460 A1
(43) Pub. Date: Sep. 10, 2009

(54) BIOACTIVE GAS SUPPLY CHAMBER FOR ANIMAL RESEARCH SUCH AS HYPOXIA STUDIES ON NON-ANESTHETIZED SMALL ANIMALS WITH DIRECT PHYSIOLOGIC MONITORING

(75) Inventors: Eric W. Starr, Allison Park, PA (US); Bernard F. Hete, Kittanning, PA (US)

Correspondence Address: BLYNN L. SHIDELER;THE BLK LAW GROUP, 3500 BROKKTREE ROAD, SUITE 200, WEXFORD, PA, 15090, US

(73) Assignee: STARR LIFE SCIENCES CORP., Oakmont, PA (US)

(21) Appl. No.: 12/401,572

(22) Filed: Mar. 10, 2009

Related U.S. Application Data
(60) Provisional application No. 61/035,220, filed on Mar. 10, 2008.

(51) Int. Cl. A01K 1/03

(52) U.S. Cl. 119/420; 119/421

(57) ABSTRACT

A hypoxia, or other bioactive gas, chamber is provided for use in animal research conducted on non-anesthetized small animals with direct physiologic monitoring.

### CROSS-REFERENCE TO RELATED APPLICATION

This application claims the benefit of U.S. Provisional Patent Application Ser. No. 61/035,220, entitled “Bioactive Gas Supply Chamber for Animal Research such as Hypoxia Studies on Non-Anesthetized Small Animals with Direct Physiologic Monitoring”, filed on Mar. 10, 2008.

### BACKGROUND OF THE INVENTION

1. Field of the Invention

The present invention relates generally to a bioactive gas supply chamber, such as a hypoxia chamber, for use in animal research conducted on non-anesthetized small animals with physiologic monitoring.

2. Description of Related Art

Researchers who conduct experiments using rats and mice often require that their research animals be un-anesthetized during the experiment in order to avoid any effects from anesthesia that might skew the results. The primary difficulty associated with conducting tests on un-anesthetized subjects is their mobility. Some direct measurements, such as pulse oximetry, are very dependent on immobility of the subject.

Within the meaning of this application physiologic measurements will be classified as direct measurements and indirect measurements. Direct measurements are those physiologic parameters that require a sensor to be in direct contact with the subject and include as representative examples, pulse oximeters, blood pressure monitors, internal temperature measurements and the like. Indirect measurements include full body plethysmographic measurements of tidal volume.

One method commonly used for immobilizing subjects is a restraining device such as a restraint tube. Animal restraint tubes most often used in research are constructed generally of a clear plastic and have a slit that runs the entire length along the top of the tube. The tube is open on one end, and is closed on the other end, but the slit described above is joined on the closed end by a slit that runs to the center of the end cap.

To use the tube, one grabs the animal's tail, and pulls it through the slit from the open end of the tube, toward the closed end. Once the animal is pulled all of the way into the tube, a restricting ring or plate is slid into the open end of the tube to allow the user to push the animal farther into the tube and restrict its motion. With the securing of the restricting ring the animal is effectively immobilized and the research can proceed. The majority of animal restraint tubes allow certain access to the animal with the animal being fully conscious, and the restraint tubes have been used in a wide variety of research applications.

Hypoxia literally translate as a deficiency in oxygen. The medical definition of Hypoxia is a shortage of oxygen in the body. Hypoxaemia is the reduction of oxygen specifically in the blood; anoxia is when there is no oxygen available at all. Biomedical research into hypoxia requires atmospheric control system. The pulminary research solutions offered by Buxco (www.Buxco.com) are also relevant to this field, although not expressly disclosed for hypoxia studies, see for example. These include unrestrained whole body chambers, specialized sealed restraint tubes, and even a head out chamber device for monitoring respiratory and related functions in small animals.

These devices are generally associated with what is called full body plethysmography generally for assessing lung function. This approach to assess lung function involves placing the subject into a small closed box and measuring the pressure changes within the box that occur as the animal breathes. The animal is conscious and unrestrained. This technique currently enjoys wide popularity because 1) it is simple and 2) the subject, such as a mouse, remains unharmed after the experiment. The endpoint is the heuristic variable known as Penh, which stands for ‘enhanced pause’. Some publications draw into serious question the validity of using Penh to measure lung function. Regardless these systems are not well suited for monitoring other physiologic parameters that require the sensors to be in intimate contact with the subject, such as pulse oximetry, blood pressure, internal temperature, etc.

The limitation in the existing systems is that they hinder the ease and types of research that are conducted. As a representative illustration see the 2003 study from University of Washington Medical Center regarding “Oxygen regulation and limitation to cellular respiration in mouse skeletal muscle in vivo” in which the researchers describe the development of “novel” methodology for measuring oxygen consumption in the subject mice. See also the 1998 study from Case Western Reserve regarding the “Altered respiratory responses to hypoxia in mutant mice deficient in neuronal nitric oxide synthase” wherein the experiments were conducted on awake and anaesthetized mutant and wild-type control mice. For the study of the un-anesthetized subjects the physiologic parameters were limited to the whole body plethysmograph described above and monitoring of oxygen consumption and carbon dioxide production from gas monitoring of the chamber vent.

There is a need to assist researchers for conducting respiratory research on animals, such as hypoxia studies, to provide bioactive gas supply mechanisms that allow for studies on conscious animals and which allow for direct measurements of physiologic parameters. It is an object of the present invention to provide a wider variety of easily utilized tools to the animal researcher.

### SUMMARY OF THE INVENTION

The inventors of the present invention provides a bioactive gas supply chamber that may be used in a hypoxia chamber system provided for use in animal research conducted on non-anesthetized small animals with direct physiologic monitoring of the animals.

These and other advantages of the present invention will be clarified in the detailed description of the preferred embodiments taken together with the attached figures wherein like reference numerals reference like elements throughout.

### BRIEF DESCRIPTION OF THE DRAWINGS

FIG. 1 is a schematic view of a hypoxia chamber system provided for use in animal research conducted on non-anesthetized small animals with direct physiologic monitoring in accordance with one aspect of the present invention;

FIG. 2 is a schematic view illustrating the easy insertion and removal of a animal restraint tube from the hypoxia chamber of the hypoxia chamber system of FIG. 1; and

FIG. 3 is a schematic perspective view of a hypoxia chamber of the hypoxia chamber system of FIG. 1.

### DETAILED DESCRIPTION OF THE INVENTION

It is noted that, as used in this specification and the appended claims, the singular forms “a,” “an,” and “the” include plural referents unless expressly and unequivocally limited to one referent. The various embodiments and examples of the present invention as presented herein are each understood to be non-limiting with respect to the scope of the invention.

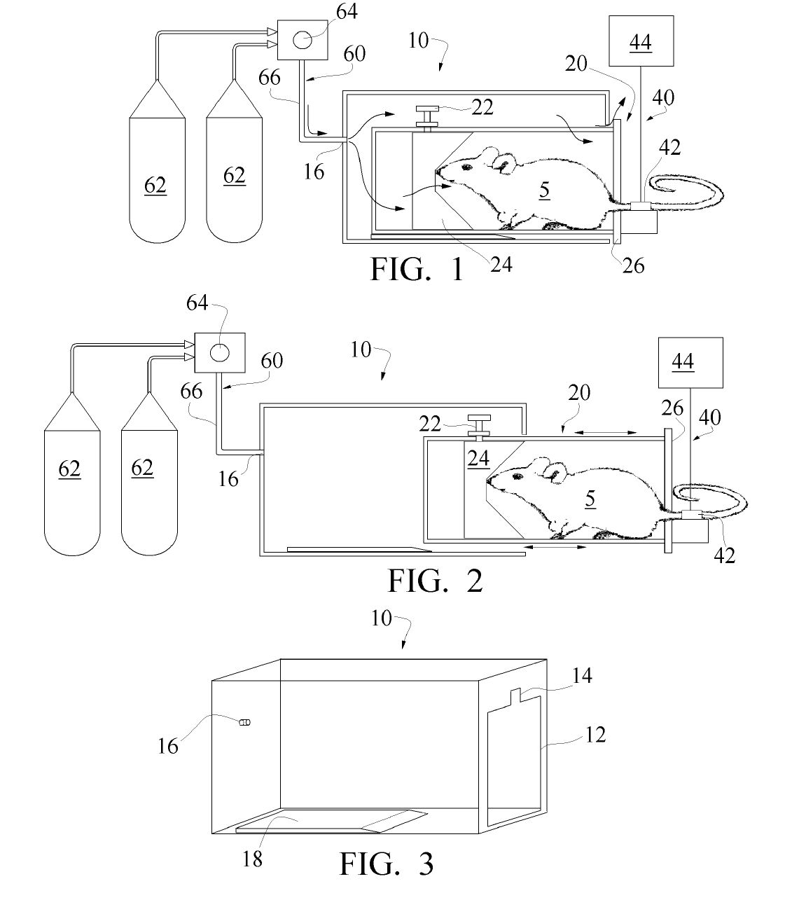

FIG. 1 is a schematic view of a hypoxia chamber system provided for use in animal research conducted on non-anesthetized small animals, such as mice 5, with direct physiologic monitoring in accordance with one aspect of the present invention.

A key component of the hypoxia chamber system is a hypoxia chamber 10. The chamber 10 can also be referenced as a bioactive gas chamber within the meaning of the present invention as it can be used with any combination of bioactive gases and is not limited to hypoxia studies.

The chamber 10 may be formed of any gas impermeable material, such as plastic and may be formed from clear plastic to aid in viewing the subject 5 throughout the experiment. Alternatively, a dark color with windows, or dark tinted or transparent material may be used to form the chamber 10, as such construction has been found to be soothing for mice and may be helpful for conducting experiments.

The chamber 10 is constructed to receive a restraint tube 20 therein. The restraint tube 20 illustrated is the STARR-GATE™ brand restraint tube from Starr Life Sciences, but other tubes can be utilized. The STARR-GATE™ brand restraint tube is preferred as it more easily accommodates a variety of direct measurement sensors 40, such as a tail mounted pulse oximeter sold under the brand name MOUSE OX™ by Starr Life Sciences.

The chamber 10 includes an open end 12 that receives the tube 20 therein and includes a notch 14 that make it easier to receive the locking nut 22 of the adjustable nose cone 24 of the tube 20. The chamber 10 includes at least one inlet 16 for the introduction of the bioactive gasses into the chamber 10 as described below. The chamber 10 includes a ledge 18 for receipt and support of the forward end of the tube 20 that will maintain the tube 20 and animal 5 substantially level.

The end of the chamber 10 with the opening 12 and notch 14 will abut the end plate 26 of the tube 20, but it is not intended for this to be an airtight seal. The gap between the opening 12 (including notch 14) and the end plate 26 serves to form a vent in the functioning chamber 10.

The shape of the chamber 10 is shown as generally rectangular, but any shape that can receive the tube 20 is acceptable. The opening 12 should conform to the shape of the back plate 26, in general. The ledge 18 is formed with a leading ramp to allow the user to easily slide the tube 20 into position as generally represented in FIG. 2.

The chamber 10 accommodates the tube 20 which allows for direct measurement through a direct physiologic sensor monitor shown generally at 40. The monitor 40 includes a tail mounted sensor 42 coupled to an associated controller, recorder and display device 44. The Mouse OX™ brand pulse oximeter from Starr Life Sciences is one type of direct measurement physiologic sensor. Tail cuff blood pressure monitors represent another illustrative direct measurement sensor that is accommodated with the tube 20. Rectal temperature monitors represent another illustrative direct measurement sensor that is accommodated with the tube 20. Any of a wide variety of animal contacting sensors can be used depending upon the needs of the researcher.

A bioactive gas supply 60 is coupled to the inlet 16 and adapted to selectively supply the needed gas to the subject 5. The Oxydial™ gas supply device from Starr Life Sciences represents one type of bioactive gas supply system that can be used to form the supply 60. In the supply 60 a plurality of distinct gasses are supplied from gas sources 62 to a blender valve 64 which can selectively combine the gases to the desired mix and supply these to the inlet 16 via blender outlet 66. The gas sources 62 may be, for example, oxygen and nitrogen, whereby the researcher can selectively mix these to have any combination of the two gasses from 0% oxygen to 100% oxygen. The gas sources 62 may be, for example, air and nitrogen, whereby the researcher can selectively mix these to have any combination of effectively oxygen and nitrogen from 0% oxygen (100% nitrogen) to 21% oxygen (i.e. 100% air), and this embodiment will give the researcher a greater precision in the blender between the 0-21% marks. Further, there is nothing preventing the supply 60 from including a mixture of 3 or more gasses to form the desired bioactive gas that is supplied to the subject 5.

Further it is anticipated that more than one sealable inlet 16 is provided so that separate supplies 60 can be coupled directly to the chamber 10 if desired. Functionally, the chamber 10 would operate the same. It is preferred if the inlet 16 is opposed from the vent formed by the opening 12 to form a flow through the entire chamber 10 in operation.

The chamber 10 of the present invention is very easily used by researchers as they merely utilize existing restraint tubes 20 and slide them into the chamber 10. The system 10 can be used with any bioactive gas combination that can be vented to atmosphere. An overriding containment or hood vent may be required for some bioactive gases that have venting restrictions. The present invention intends to open up a whole world or research possibilities for rapid, cost effective animal research.

The present invention has been described with reference to specific details of particular embodiments thereof. It is not intended that such details be regarded as limitations upon the scope of the invention except insofar as and to the extent that they are included in the accompanying claims. A number of variations to the present invention will be apparent to those of ordinary skill in the art and these variations will not depart from the spirit and scope of the present invention. The scope of the invention is defined by the appended claims and equivalents thereto.

We claim:

1. A hypoxia chamber for use in animal research conducted on non-anesthetized small animals with direct physiologic monitoring, the chamber including an open end configured to receive an animal restraint tube, the chamber includes at least one inlet configured for the introduction of the bioactive gasses into the chamber.

2. The chamber according to claim 1, wherein the chamber further includes a ledge for receipt and support of the forward end of the animal restraint tube that will maintain the tube and animal substantially level.

3. The chamber according to claim 2, wherein the open end includes a notch.

4. The chamber according to claim 3, wherein the chamber is rectangular.

5. The chamber according to claim 4, wherein the ledge is formed with a leading ramp configured to allow the user to easily slide the tube into position.

6. The chamber according to claim 5, wherein the chamber is opaque.

7. The chamber according to claim 5, wherein the chamber is transparent.

8. The chamber according to claim 5, wherein the back plate is replaceable to allow for restraint tubes of differing sizes and shapes.

9. A hypoxia chamber system for use in animal research conducted on non-anesthetized small animals with direct physiologic monitoring, the system comprising an animal restraint tube and the chamber including an open end configured to receive the animal restraint tube, the chamber including at least one inlet configured for the introduction of the bioactive gasses into the chamber.

10. The chamber system according to claim 9, wherein the chamber further includes a ledge for receipt and support of the forward end of the animal restraint tube that will maintain the tube and animal substantially level.

11. The chamber system according to claim 10, wherein the open end includes a notch.

12. The chamber system according to claim 11, wherein the chamber is rectangular.

13. The chamber system according to claim 12, wherein the ledge is formed with a leading ramp configured to allow the user to easily slide the tube into position.

14. The chamber system according to claim 13, wherein the chamber is opaque.

15. The chamber system according to claim 13, wherein the chamber is transparent.

16. The chamber according to claim 15, wherein the back plate is replaceable to allow for restraint tubes of differing sizes and shapes.

17. The chamber system according to claim 9 further including a bioactive gas supply is coupled to the inlet and adapted to selectively supply the needed gas to the subject.

18. The chamber system according to claim 17 wherein the gas supply is configured to supply a plurality of distinct gasses to a blender valve which can selectively combine the gases to the desired mix and supply these to the inlet via blender outlet.

19. A hypoxia chamber system for use in animal research conducted on non-anesthetized small animals with direct physiologic monitoring, the system comprising an animal restraint tube and the chamber including an open end configured to receive the animal restraint tube slid into the chamber, the chamber including at least one inlet configured for the introduction of the bioactive gasses into the chamber, and wherein the open end provides a vent outlet.
